(19) United States
(12) Patent Application Publication
(10) Pub. No.: US 2026/0077621 A1
(43) Pub. Date: Mar. 19, 2026

(54) LOCKING AIR CHUCK

(71) Applicant: Tyler Laursen, Sacramento, CA (US)

(72) Inventor: Tyler Laursen, Sacramento, CA (US)

(21) Appl. No.: 18/886,838

(22) Filed: Sep. 16, 2024

(51) Int. Cl. B60C 29/06

(52) U.S. Cl. CPC B60C 29/064

(57) ABSTRACT

A locking air chuck. The locking air chuck includes a nozzle, where the nozzle is configured to be placed on an air stem and a body, where the body is attached to the nozzle. The locking air chuck also includes a collar, where the collar is outside the nozzle and configured to slide relative to the nozzle. The locking air chuck further includes one or more locking teeth, the one or more locking teeth configured to engage the air stem and be pressed through the nozzle by the collar.

### CROSS-REFERENCE TO RELATED APPLICATIONS

Not applicable.

### BACKGROUND OF THE INVENTION

Air chucks are devices which are used to attach an air hose to an air stem of a tire. In many cases, and air hose is connected to an air tank or compressor and the air chuck is pressed against the air stem, creating a connection through which air can flow. For a single wheel, this works because the user is generally adding a small amount of air to a tire and so there isn't an inconvenience in doing so.

However, if a user is inflating or deflating more than one tire at the same time then this doesn't work because the user can't reach both air stems to press the air chuck against the air stem. In addition, for longer operations (such as inflating large tires or inflating multiple tires) this can become unworkable because the user can't maintain the required pressure for such long amounts of time.

The solution to this problem is the creation of locking air chucks. The most common type of locking air chuck uses a lever system. There is a spring biased lever that when pressed opens the mouth of the air chuck allowing it to be placed around an air stem. The lever is then released and the mouth closes, pinching the air stem. This works well, unless the air stem is difficult to reach, which is the case in many air stems.

For example, many off-roading wheels have “protected” air stems that are difficult to reach. This means that both conventional air chucks and lever style locking air chucks are unable to be placed on the air stem.

Accordingly, there is a need in the art for a locking air chuck that can be used on wheels with hard to reach air stems, such as off-road wheels.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a locking air chuck. The locking air chuck includes a nozzle, where the nozzle is configured to be placed on an air stem and a body, where the body is attached to the nozzle. The locking air chuck also includes a collar, where the collar is outside the nozzle and configured to slide relative to the nozzle. The locking air chuck further includes one or more locking teeth, the one or more locking teeth configured to engage the air stem and be pressed through the nozzle by the collar.

Another example embodiment includes a locking air chuck. The locking air chuck includes a nozzle, where the nozzle is configured to be placed on an air stem and a gasket within the nozzle, where the gasket is configured to create a seal between the nozzle and the air stem. The locking air chuck also includes a body, where the body is attached to the nozzle and a valve, where the valve is configured to allow or prevent air flow through the nozzle. The locking air chuck further includes a collar, where the collar is outside the nozzle and configured to slide relative to the nozzle. The locking air chuck additionally includes one or more locking teeth, the one or more locking teeth configured to engage the air stem and be pressed through the nozzle by the collar.

Another example embodiment includes an air delivery system, where the air delivery system includes an air hose. The air delivery system also includes a locking air chuck. The locking air chuck comprising a nozzle, where the outer surface of the nozzle is cylindrical and the nozzle is configured to be placed on an air stem. The locking air chuck also includes a gasket within the nozzle, where the gasket is configured to create a seal between the nozzle and the air stem and a body, where the body is attached to the nozzle and the air hose. The locking air chuck further includes an O-ring, where the O-ring is between the nozzle and the body and creates an air tight seal between the nozzle and the body. The locking air chuck additionally includes a valve, where the valve is configured to allow or prevent air flow through the nozzle and a spring, where the spring is configured to bias the valve into a closed position. The locking air chuck moreover includes a collar, where the inner surface of the collar is cylindrical and the inner diameter of the collar is larger than the outer diameter of the nozzle, the collar is placed with the inner surface adjacent to the outer surface of the nozzle, and the collar is configured to slide relative to the nozzle. The locking air chuck also includes three locking teeth. The three locking teeth are each configured to engage the air stem and at least partially pass through an opening in the nozzle by the collar.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates an example of a locking air chuck;

FIG. 1B illustrates an expanded view of the example of a locking air chuck; and

FIG. 2 illustrates an example of a locking air chuck attached to an air hose.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

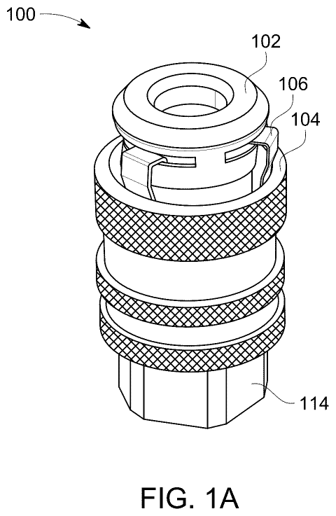

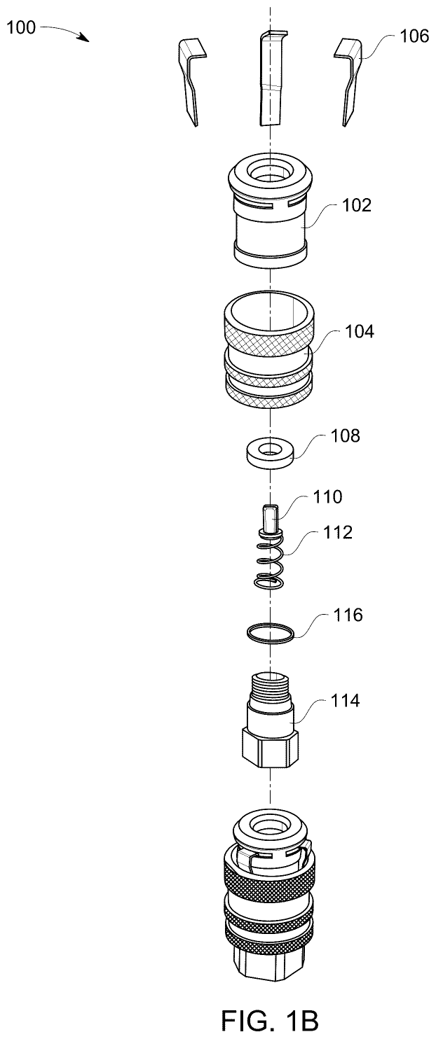

FIGS. 1A and 1B (collectively “FIG. 1”) illustrates an example of a locking air chuck 100. FIG. 1A illustrates an example of a locking air chuck 100 and FIG. 1B illustrates an expanded view of the example of a locking air chuck 100. The locking air chuck 100 attaches to the stem valve of a tire and then locks into place. The benefit of a locking air chuck 100 is that it remains in place without the user having to apply force. This allows a user to attach multiple locking air chucks 100 and to attach the locking air chuck 100 and do other things, such as monitor the air pressure. Further, the locking air chuck 100 can be used on stem valves that are hard to access because once it is attached it remains in place.

FIG. 1 shows that the locking air chuck 100 can include a nozzle 102. The nozzle 102 is configured to be placed around an air stem creating a direct connection between the locking air chuck 100 and the air stem. The inner diameter of the nozzle 102 is larger than the outer diameter of the air stem, allowing the nozzle 102 to be placed over the air stem. As used in the specification and the claims, the phrase “configured to” denotes an actual state of configuration that fundamentally ties recited elements to the physical characteristics of the recited structure. That is, the phrase “configured to” denotes that the element is structurally capable of performing the cited element but need not necessarily be doing so at any given time. Thus, the phrase “configured to” reaches well beyond merely describing functional language or intended use since the phrase actively recites an actual state of configuration.

FIG. 1 also shows that the locking air chuck 100 can include a collar 104. The collar 104 is placed around the nozzle 102. That is, the inner surface of the collar 104 can be cylindrical where the diameter of the collar 104 is larger than the outer diameter of the nozzle 102, allowing the entirety of the collar to be outside of the nozzle. This allows the collar 104 to move relative to the nozzle 102. In addition, the collar 104 can include a grip surface, making it easier for a user to hold the collar 104. Usage of the locking air chuck 100 in off-roading conditions has shown that the outer diameter of the collar 104 is critical for the proper operation of the locking air chuck 100. For many air chucks, a larger outer diameter is often used because size isn't an issue and it ensures that the collar 102 is of sufficient strength to perform all necessary functions. However, air chucks with a larger outer diameter have a problem in that they can't reach tighter spaces. This is a problem since most air chucks are designed for wheels with easily accessible air stems. However, many specialty wheels have air stems that are more difficult to reach because the wheel is designed to protect the air stem of the tire. Therefore, experimentation has shown that a smaller outer diameter of the collar 104 can allow for more access, but too small an outer diameter makes the collar 104 thin and subject to failure. Thus, the collar 104 needs to be large enough to perform its functions yet small enough to fit into tight spaces. For example, the outer diameter of the collar 102 can be between 0.65 inches and 1.05 inches. In particular, the outer diameter of the collar 102 can be approximately 0.85 inches. As used in the specification and the claims, the term approximately shall mean that the value is within 10% of the stated value, unless otherwise specified.

FIG. 1 further shows that the air chuck 100 can include one or more locking teeth 106. The locking teeth 106 are pushed through the nozzle 102 by the collar 104. This allows the locking teeth 106 to “bite” onto the air stem and lock the nozzle 102 relative to the air stem. The one or more locking teeth 106 are shaped like a “7” so that as the collar 104 is moved toward the top of the one or more locking teeth 106, the horizontal portion is pushed in toward the air stem but when the collar 104 is moved away from the top the horizontal portion pulls out and disengages the air stem. I.e., the one or more locking teeth 106 act as a flat spring, with a “horizontal portion” which presses into the nozzle 102 and a “body” which biases the one or more locking teeth in an unlocked position unless pressed into the nozzle 102 by the collar 104. Additionally, the body of the one or more locking teeth 106 can be curved to provide a force which biases the horizontal portion out of the center of the nozzle. In addition, the thickness of the horizontal portion is thin enough to fit between the threads of an air stem, preventing damage to the threads on the air stem. Likewise, the positioning of the openings within the nozzle 102 are positioned so that they match the threading of the air stem. I.e., each opening is slightly offset from the others, so that once one of the one or more locking teeth 106 is aligned between the threads of an air stem, each of the other one or more locking teeth 106 will likewise be aligned between the threads of the air stem. This provides a better lock and ensures that the one or more locking teeth 106 do not damage the air stem.

FIG. 1 additionally shows that the locking air chuck 100 can include a gasket 108. The gasket 108 creates a seal between the locking air chuck 100 and the air stem of a tire. I.e., the end of the tire air stem is pressed against the gasket 108. Usage in off-roading conditions has shown that for many air stems, the gasket 108 is quite thin, which allows dirt and other debris to enter and prevents an adequate seal with the air stem. Therefore, the thickness of the gasket 108 is critical to ensure that a proper seal is achieved in off roading conditions where dirt is prevalent. For example, the gasket 108 can be between 0.14 inches and 0.22 inches thick to prevent dirt or other debris from entering the locking air chuck 100. In particular, the gasket 108 can be approximately 0.18 inches thick. Likewise, a more malleable material produces a better seal. Therefore, experimentation has shown that silicone creates a more malleable gasket 108 and establishes a better seal between the locking air chuck 100 and a tire air stem.

FIG. 1 moreover shows that the locking air chuck 100 can include a valve 110. The valve 110 pushes on the valve of an air stem (which in turn pushes back on the valve 110), opening both the valve 110 and the air stem valve to allow air into or out of the tire. I.e., when both the valve 110 and the air stem valve are open, air can flow through the locking air chuck 100 into or out of the tire via the air stem.

FIG. 1 also shows that the locking air chuck 100 can include a spring 112. The spring 112 ensures that the valve 110 will not get stuck open when it gets dirty or gummed up. I.e., when the locking air chuck 100 is placed on an air stem, the valve 110 is open. When the locking air chuck 100 is removed from the air stem, the spring 112 forces the valve 110 closed. I.e., the spring 112 pushes the valve 110 against the gasket 108, creating an air tight seal. Therefore, the thickness and the material disclosed above relative the gasket 108 are critical to ensure that an air tight seal exists between the valve 110 and the gasket 108 when the locking air chuck 100 is not placed on a tire stem. Most air chucks use back pressure (pressure produced by a compressor or within an attached air hose) to close the valve 110 but this doesn't work in conditions that are dirty. I.e., the spring and thickness and material of the gasket 108 ensure a seal that does not matter in most air chucks.

FIG. 1 further shows that the locking air chuck 100 can include a body 114. The body 114 provides a base for each of the other parts. I.e., the body 114 is threaded onto the nozzle 102. The attachment of the body 114 and nozzle 102 creates a space for the collar 104 and allows the collar 104 to move back and forth relative to the nozzle 102. In addition, the body 114 has a threaded opening (female threads), allowing an attachment to be threaded onto the body 114, as described below.

FIG. 1 additionally shows that the locking air chuck 100 can include an O-ring 116. Other air chucks use a thread sealant so that when the body 114 is attached to the nozzle 102, the sealant hardens and the nozzle 102 remains attached to the body 114. As the sealant hardens it creates a seal so that air cannot escape through the attachment threads. However, usage of air chucks in dirty environments has shown that the air chucks get dirt internally and need to be disassembled and cleaned. Therefore, use of an O-ring 116 rather than thread sealant allows the locking air chuck 100 to be disassembled for cleaning and maintenance. I.e., the body 114 can be unscrewed from the nozzle 102, cleaned and then reassembled and the O-ring 116 provides a seal to prevent air leakage.

When assembled, the depth of engagement of the locking air chuck 100 is reduced by approximately 60% relative to other air chucks. This allows complete and full valve core engagement, and to attach to shorter airs stems while maintaining a closed flow air chuck. I.e., less of the air stem is received into the locking air chuck 100 but the changes discussed herein allow for a tight seal, allowing the locking air chuck 100 to engage air stems that other air chucks would not be able to attach to. In addition, the locking air chuck 100 is more fully engaged with the air stem of a wheel. Particularly, the locking air chuck 100 presses on the valve of the wheel stem more fully, opening the valve of the wheel stem up to 90% of the total potential opening rather than the 10-40% achieved by most air chucks. This provides greater air flow between the locking air chuck 100 and the wheel stem.

By way of example, a description of usage of the locking air chuck 100 is described herein. The locking air chuck 100 is placed with the nozzle 102 as far as possible on the stem valve of a tire with collar 104 pulled all the way back. The user then slides the collar 104 forward while holding pressure on the valve stem, engaging the one or more locking teeth 106 on the air stem. Unless placed on a stem valve, the locking air chuck 100 defaults to a closed position to prevent air leakage because of the spring 112. Thus, if three locking air chucks 100 are placed on tires and a fourth locking air chuck 100 is left free, air will only flow through the three air hoses which are connected to tires via a locking air chuck 100.

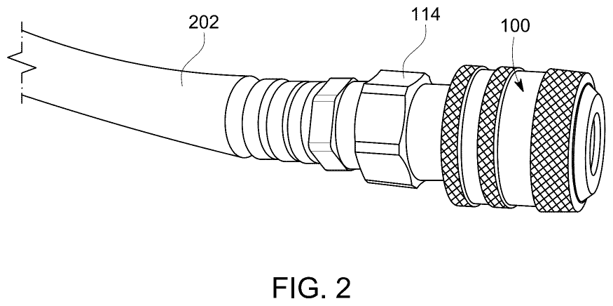

FIG. 2 illustrates an example of a locking air chuck 100 attached to an air hose 202. The air hose 202 can be attached to any desired object. For example, the air hose 202 can be attached to an air tank, a compressor, other tires, etc. Air can flow through the air hose 202 and the locking air chuck 100 to any object (for example, an air stem) to which the locking air chuck 100 is attached.

FIG. 2 shows that the air hose 202 is attached to the body 114 of the locking air chuck 100. For example, the air hose 202 can be threaded onto the threaded opening of the body 114. Other connections can include hose barbs and crimped ferrules. Once the attachment occurs, air can pass though the locking air chuck 100 to fill or let air out of the item to which the locking air chuck 100 is attached.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A locking air chuck, the locking air chuck comprising:
a nozzle, wherein the nozzle is configured to be placed on an air stem;
a body, wherein the body is attached to the nozzle;
a collar, wherein the collar is:
outside the nozzle; and
configured to slide relative to the nozzle; and
one or more locking teeth, the one or more locking teeth:
configured to engage the air stem; and
be pressed through the nozzle by the collar.

2. The locking air chuck of claim 1 wherein the outer diameter of the collar is between 0.65 inches and 1.05 inches.

3. The locking air chuck of claim 2 wherein the outer diameter of the collar is approximately 0.85 inches.

4. The locking air chuck of claim 1 further comprising a gasket within the nozzle, wherein the gasket is configured to create a seal between the nozzle and the air stem.

5. The locking air chuck of claim 1, wherein the body includes a threaded opening.

6. The locking air chuck of claim 1, wherein the outer surface of the nozzle is cylindrical.

7. The locking air chuck of claim 6, wherein the inner surface of the collar is cylindrical.

8. The locking air chuck of claim 1, wherein the one or more locking teeth are attached to the body.

9. The locking air chuck of claim 1, wherein at least a portion of each of the one or more locking teeth pass though an opening in the nozzle.

10. The locking air chuck of claim 1, wherein the one or more locking teeth are a flat spring.

11. The locking air chuck of claim 1, wherein the one or more locking teeth includes a body, wherein the body is curved to provide a bias for the one or more locking teeth in an unlocked position.

12. The locking air chuck of claim 1, wherein the collar includes a grip surface.

13. A locking air chuck, the locking air chuck comprising:
a nozzle, wherein the nozzle is configured to be placed on an air stem;
a gasket within the nozzle, wherein the gasket is configured to create a seal between the nozzle and the air stem;
a body, wherein the body is attached to the nozzle;
a valve, wherein the valve is configured to allow or prevent air flow through the nozzle;
a collar, wherein the collar is:
outside the nozzle; and
configured to slide relative to the nozzle; and
one or more locking teeth, the one or more locking teeth:
configured to engage the air stem; and
be pressed through the nozzle by the collar.

14. The locking air chuck of claim 13, wherein the gasket is between 0.14 inches and 0.22 inches thick.

15. The locking air chuck of claim 14, wherein the gasket is approximately 0.18 inches thick.

16. The locking air chuck of claim 13, wherein the gasket includes silicone.

17. The locking air chuck of claim 13 further comprising a spring, wherein the spring is configured to bias the valve into a closed position.

18. The locking air chuck of claim 13 further comprising an O-ring, wherein the O-ring:
is between the nozzle and the body; and
creates an air tight seal between the nozzle and the body.

19. An air delivery system, wherein the air delivery system includes:
an air hose;
a locking air chuck, the locking air chuck comprising:
a nozzle, wherein:
the outer surface of the nozzle is cylindrical; and
the nozzle is configured to be placed on an air stem;
a gasket within the nozzle, wherein the gasket is configured to create a seal between the nozzle and the air stem;
a body, wherein the body is attached to:
the nozzle; and
the air hose;
an O-ring, wherein the O-ring:
is between the nozzle and the body; and
creates an air tight seal between the nozzle and the body;
a valve, wherein the valve is configured to allow or prevent air flow through the nozzle;
a spring, wherein the spring is configured to bias the valve into a closed position;
a collar, wherein:
the inner surface of the collar is cylindrical;
the inner diameter of the collar is larger than the outer diameter of the nozzle;
the collar is placed with the inner surface adjacent to the outer surface of the nozzle; and
the collar is configured to slide relative to the nozzle; and
three locking teeth, wherein the three locking teeth are each configured to:
engage the air stem; and
at least partially pass through an opening in the nozzle by the collar.

20. The air delivery system of claim 19 wherein the connection between the body and the air hose is a threaded connection.
